(19) United States
(12) Patent Application Publication
(10) Pub. No.: US 2018/0120682 A1
(43) Pub. Date: May 3, 2018

(54) LIGHTING PROJECTION DEVICE AND PROJECTION MODULE HAVING SAME

(71) Applicant: IVIEW DISPLAYS (SHENZHEN) COMPANY LTD., Shenzhen (CN)

(72) Inventors: Zhiqiang Gao, Hong Kong (CN); Yuan Zhao, Shenzhen (CN); Steve Yeung, Hong Kong (CN); Qingyun Lin, Shenzhen (CN)

(21) Appl. No.: 15/851,804

(22) Filed: Dec. 22, 2017

Related U.S. Application Data
(63) Continuation of application No. PCT/CN2016/083253, filed on May 25, 2016.

(30) Foreign Application Priority Data
Sep. 21, 2015 (CN) 201520733792.3

(51) Int. Cl. G03B 21/20; G02B 27/14; G02B 1/11; G03B 33/12

(52) U.S. Cl. CPC G03B 21/208; G03B 21/2066; G02B 27/141; G03B 33/12; G03B 21/2013; G03B 21/2033; G02B 1/11

(57) ABSTRACT

A lighting projection device and a projection module having the same are disclosed. The lighting projection device includes: a light source of three primary colours including a first light source, a second light source and a third light source; a first collimating lens group, a second collimating lens group, and a third collimating lens group; a first dichroic mirror and a second dichroic mirror; and a first fly-eye lens, a second fly-eye lens, and a third fly-eye lens, the first fly-eye lens, the second fly-eye lens and the third fly-eye lens each including a light incident surface facing the light source of three primary colours, and the light incident surface of each of the first fly-eye lens, the second fly-eye lens, and the third fly-eye lens including the same fly-eye lens array.

### CROSS-REFERENCE TO RELATED APPLICATIONS

This application is a continuation of International Application No. PCT/CN2016/083253, with an international filing date of May 25, 2016, which is based upon and claims priority to Chinese Patent Application No. 201520733792.3, filed on Sep. 21, 2015, the entire contents of which are incorporated herein by reference.

### TECHNICAL FIELD

The present disclosure relates to the field of digital projection display, and particularly, to a lighting projection device and a projection module having the same.

### BACKGROUND

With the development of science and technology, especially the advancement of semiconductor technology, portable electronic devices are constantly designed and manufactured. With the functional upgrading of portable electronic devices, the user's requirements for human-computer interface (HMI) display devices are developing towards miniature, large screen and high resolution. In recent years, under the impetus of the increasing demand of users, pico projector technology has developed rapidly. For example, based on the technology of Digital Light Processing (DLP) and Liquid Crystal On Silicon (LCOS), products including portable handheld micro projectors (PICO), or projector modules built in handheld mobile devices such as mobile phones and the like, have been constantly launched.

In general, conventional projectors are used to first converging light beams from three light sources and then homogenizing the converged light beams by using a fly-eye lens or an optical wand.

### SUMMARY

An embodiment of the present disclosure provides a lighting projection device. The lighting projection device includes:

a light source of three primary colours including a first light source, a second light source and a third light source;

a first collimating lens group positioned on a light path of the first light source, a second collimating lens group positioned on a light path of the second light source, and a third collimating lens group positioned on a light path of the third light source;

a first dichroic mirror and a second dichroic mirror; and

a first fly-eye lens, a second fly-eye lens, and a third fly-eye lens, the first fly-eye lens, the second fly-eye lens and the third fly-eye lens each including a light incident surface facing the light source of three primary colours, and the light incident surface of each of the first fly-eye lens, the second fly-eye lens, and the third fly-eye lens including the same fly-eye lens array;

wherein,

a light beam emitted from the first light source is collimated by the first collimating lens group and penetrates through the first dichroic mirror, and a light beam emitted from the second light source is collimated by the second collimating lens group and is reflected by the first dichroic mirror; the first fly-eye lens is positioned on a light path of the first dichroic mirror, and the light beam penetrating through the first dichroic mirror and the light beam reflected by the first dichroic mirror converge on a light incident surface of the first fly-eye lens;

the second fly-eye lens is positioned on a light path of the third collimating lens group, a light beam emitted from the third light source is collimated by the third collimating lens group and enters the light incident surface of the second fly-eye lens;

a light beam from the first fly-eye lens is reflected by the second dichroic mirror, and a light beam from the second fly-eye lens penetrates through the second dichroic mirror; the third fly-eye lens is positioned on a light path of the second dichroic mirror; and the light beam penetrating through the second dichroic mirror and the light beam reflected by the second dichroic mirror converge on a light incident surface of the third fly-eye lens.

Another embodiment of the present disclosure provides a projection module. The projection module includes:

a lighting projection device, a relay lens, a rectangular prism, a display chip and a projection lens group;

wherein the lighting projection device includes:

a light source of three primary colours including a first light source, a second light source and a third light source;

a first collimating lens group positioned on a light path of the first light source, a second collimating lens group positioned on a light path of the second light source, and a third collimating lens group positioned on a light path of the third light source;

a first dichroic mirror and a second dichroic mirror; and

a first fly-eye lens, a second fly-eye lens, and a third fly-eye lens, the first fly-eye lens, the second fly-eye lens and the third fly-eye lens each including a light incident surface facing the light source of three primary colours, and the light incident surface of each of the first fly-eye lens, the second fly-eye lens, and the third fly-eye lens including the same fly-eye lens array;

wherein,

a light beam emitted from the first light source is collimated by the first collimating lens group and penetrates through the first dichroic mirror, and a light beam emitted from the second light source is collimated by the second collimating lens group and is reflected by the first dichroic mirror; the first fly-eye lens is positioned on a light path of the first dichroic mirror, and the light beam penetrating through the first dichroic mirror and the light beam reflected by the first dichroic mirror converge on a light incident surface of the first fly-eye lens;

the second fly-eye lens is positioned on a light path of the third collimating lens group, a light beam emitted from the third light source is collimated by the third collimating lens group and enters the light incident surface of the second fly-eye lens;

a light beam from the first fly-eye lens is reflected by the second dichroic mirror, and a light beam from the second fly-eye lens penetrates through the second dichroic mirror; the third fly-eye lens is positioned on a light path of the second dichroic mirror; and the light beam penetrating through the second dichroic mirror and the light beam reflected by the second dichroic mirror converge on a light incident surface of the third fly-eye lens;

and wherein the relay lens is positioned on the light path of the third fly-eye lens, a homogenized light beam emitted from the lighting projection device is received and converged by the relay lens; the rectangular prism is positioned on the light path of the relay lens, a light beam emitted from the relay lens is guided to the display chip positioned at the side of the rectangular prism; the projection beam from the display chip is reflected by a side face of the rectangular prism and is guided to the projection lens group.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic diagram of a lighting projection device in an exemplary embodiment of the present disclosure; and

FIG. 2 is a schematic diagram of a projection module in an exemplary embodiment of the present disclosure.

### DETAILED DESCRIPTION

The implementation of the present disclosure is described in detail with the attached drawings, but it should be understood that the scope of protection of the present disclosure is not limited by the specific modes of implementation.

Unless otherwise stated expressly, the term “include” or an analogue thereof such as “contain” or “comprise” in the specification and claims should be understood to include the declarative elements or components, but do not exclude other elements or components.

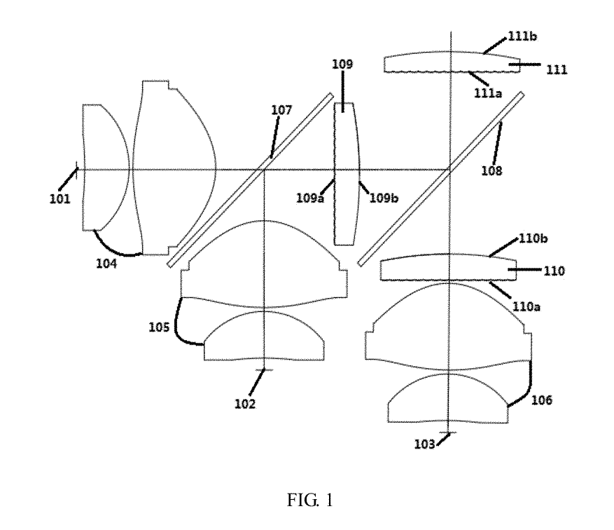

FIG. 1 is a schematic diagram of a lighting projection device in an exemplary embodiment of the present disclosure. As shown in FIG. 1, a lighting projection device in the embodiment includes:

a light source of three primary colours including a first light source 101, a second light source 102 and a third light source 103;

a first collimating lens group 104 positioned on a light path of the first light source 101, a second collimating lens group 105 positioned on a light path of the second light source 102, and a third collimating lens group 106 positioned on a light path of the third light source 103;

a first dichroic mirror 107 and a second dichroic mirror 108 which are configured to change the light path so as to converge the light source of three primary colours;

a first fly-eye lens 109, a second fly-eye lens 110, and a third fly-eye lens 111 which are configured to homogenize light beams;

a light beam emitted from the first light source 101 is collimated by the first collimating lens group 104 and penetrates through the first dichroic mirror 107, and a light beam emitted from the second light source 102 is collimated by the second collimating lens group 105 and is reflected by the first dichroic mirror 107; the first fly-eye lens 109 is positioned on a light path of the first dichroic mirror 107, and the light beam penetrating through the first dichroic mirror 107 and the light beam reflected by the first dichroic mirror 107 converge on a light incident surface 109a of the first fly-eye lens 109; the light beam emitted from the first light source 101 and the light beam emitted from the second light source 102 are collimated by the first collimating lens group 104 and the second collimating lens group 105, respectively, processed by the first dichroic mirror 107, and then converge on the light incident surface 109a of the first fly-eye lens 109; the second fly-eye lens 110 is positioned on a light path of the third collimating lens group 106, and homogenizes the light beam collimated by the third collimating lens group 106; a light beam from the first fly-eye lens 109 is reflected by the second dichroic mirror 108, and a light beam from the second fly-eye lens 110 penetrates through the second dichroic mirror 108; the third fly-eye lens 111 is positioned on a light path of the second dichroic mirror 108; and the light beam penetrating through the second dichroic mirror 108 and the light beam reflected by the second dichroic mirror 108 converge on a light incident surface 111a of the third fly-eye lens 111, and enter the third fly-eye lens 111 for another light homogenization.

In the embodiment, the light source of three primary colours is an LED light source or a laser light source; preferably, the three primary colours LED light source includes a red LED light source, a blue light source and a green LED light source.

In the embodiment, the first collimating lens group 104 is positioned on the light path of the first light source 101, the second collimating lens group 105 is positioned on the light path of the second light source 102, and the third collimating lens group 106 is positioned on the light path of the third light source 103. The three collimating lens groups are configured to receive and homogenize the natural light from the first light source 101, the second light source 102, and the third light source 103, respectively; an optical axis of the first collimating lens group 104 is coincident to that of the first light source 101, an optical axis of the second collimating lens group 105 is coincident to that of the second light source 102, and an optical axis of the third collimating lens group 106 is coincident to that of the third light source 103; in the embodiment, the optical axis of the second collimating lens group 105 is parallel to the optical axis of the third collimating lens group 106, and/or the optical axis of the second collimating lens group 105 is orthogonal to the optical axis of the first collimating lens group 104.

In the embodiment, the first dichroic mirror 107 and the second dichroic mirror 108 are parallel to each other, and are used to converge the light source of three primary colours; the light incident surface of the first dichroic mirror 107 facing the first light source 101 allows the incident light to penetrate through, and the light incident surface of the first dichroic mirror 107 facing the second light source 102 can reflect the incident light; the light beam emitted from the first light source 101 is homogenized by the first collimating lens group 104, penetrates through the first dichroic mirror 107, and the light beam emitted from the second light source 102 is homogenized by the second collimating lens group 105, and is reflected by the first dichroic mirror 107; under the action of the first dichroic mirror 107, the light beam from the first light source 101 and the light beam from the second light source 102 converge and enter the first fly-eye lens 109, and then the first fly-eye lens 109 homogenizes the converged beam emitted from the first dichroic mirror 107; the light incident surface of the second dichroic mirror 108 facing the first fly-eye lens 109 can reflect the incident light, and the light incident surface of the second dichroic mirror 108 facing the second fly-eye lens 110 allows the incident light to penetrate through; the second dichroic mirror 108 reflects the light beam from the first fly-eye lens 109, and allows the light beam from the second fly-eye lens 110 to penetrate through, so that the light beams converge on the light incident surface 111a of the third fly-eye lens 111 and enter the third fly-eye lens 111 for another light homogenization.

In this embodiment, an included angle between the first dichroic mirror 107 and an optical axis of the first collimating lens group 104 is 45 degrees, and an included angle between the first dichroic mirror 107 and an optical axis of the second collimating lens group 105 is 45 degrees; an included angle between the second dichroic mirror 108 and an optical axis of the first collimating lens group 104 is 45 degrees, and an included angle between the second dichroic mirror 108 and an optical axis of the third collimating lens group 106 is 45 degrees.

In the embodiment, the first collimating lens group 104, the second collimating lens group 105, and the third collimating lens group 106 may employ curved lenses or the like.

In the embodiment, a light incident surface of the first dichroic mirror 107 facing the first light source 101 is provided with an anti-reflective coating, and a light incident surface of the first dichroic mirror 107 facing the second light source 102 is provided with a reflection increasing coating; a light incident surface of the second dichroic mirror 108 facing the first fly-eye lens 109 is provided with a reflection increasing coating, and a light incident surface of the second dichroic mirror 108 facing the second fly-eye lens 110 is provided with an anti-reflective coating.

In the embodiment, the light incident surface 109a of the first fly-eye lens 109, the light incident surface 110a of the second fly-eye lens 110 and the light incident surface 111a of the third fly-eye lens 111 facing the light source of three primary colours include the same fly-eye lens array, the light incident surfaces (109a/110a/111a) include a fly-eye lens array including a plurality of small lenses; the small lenses have the same curvature or number, and can homogenize the light beams. It should be noted that, an optical axis of the second fly-eye lens 110 is coaxial with an optical axis of the third fly-eye lens 111, the first fly-eye lens 109 is orthogonal to the second fly-eye lens 110 or the third fly-eye lens 111, and an optical axis of the first fly-eye lens 109 is vertical to an optical axis of the second fly-eye lens 110 or the third fly-eye lens 111; the light emitting surface 109b of the first fly-eye lens 109, the light emitting surface 110b of the second fly-eye lens 110, and the light emitting surface 111b of the first fly-eye lens 111 are flat or curved surfaces, and are opposite to corresponding light incident surfaces thereof, respectively. When the light emitting surface 109b of the first fly-eye lens 109, the light emitting surface 110b of the second fly-eye lens 110, and the light emitting surface 111b of the third fly-eye lens 111 are curved surfaces, the curved surfaces can homogenize and converge the light beams, without involving a relay lens, thus reducing the size and production cost of a projectors.

In the embodiment, the first fly-eye lens 109, the second fly-eye lens 110 and the third fly-eye lens 111 can also be arranged in other angles, and meanwhile, the included angles between the first dichroic mirror 107 and the fly-eye lenses, and the included angles between the second dichroic mirror 108 and the fly-eye lenses can also be other angles, only the following condition can be satisfied: the first dichroic mirror 107 can converge the light beam from the first light source 101 and the light beam from the second light source 102, and meanwhile the second dichroic mirror 108 can converge the light beam from the first dichroic mirror 107 and the light beam from the third light source 103.

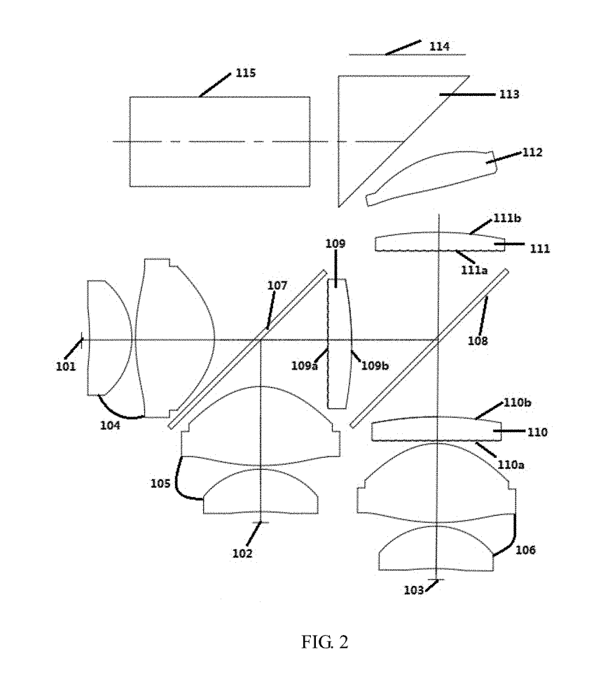

FIG. 2 is a schematic diagram of a projection module in an exemplary embodiment of the present disclosure. As shown in FIG. 2, the projection module includes: the aforesaid lighting projection device, a relay lens 112, a rectangular prism 113, a display chip 114, and a projection lens group 115.

In the embodiment, the relay lens 112 is positioned on the light path of the third fly-eye lens 111, and is configured to receive and converge a homogenized light beam from the lighting projection device; the rectangular prism 113 is positioned on the light path of the relay lens 112, and is configured to guide the light beam emitting from the relay lens 112 to the display chip 114 positioned at the side of the rectangular prism 113; the projection beam from the display chip 114 is reflected by a side face of the rectangular prism 113, and then is guided to the projection lens group 115.

In the embodiment, the material of the lens or lens group is glass, plastic, or other transparent material.

In summary, in the lighting projection device and the projection module having the same, the light paths of three light sources and the collimation paths thereof are independent from each other, the light beams can be homogenized by using three fly-eye lenses each including a single face fly-eye lens array, so the lighting projection device and the projection module having the same have simple and reasonable structure, are easy to process, and can ensure the output efficiency of each light source.

Finally it shall be noted that, the above embodiments are only used to describe but not to limit the technical solutions of the present disclosure; and within the concept of the present disclosure, technical features of the above embodiments or different embodiments may also be combined with each other, many other variations in different aspects of the present disclosure described above are possible although, for purpose of simplicity, they are not provided in the details. Although the present disclosure has been detailed with reference to the above embodiments, those of ordinary skill in the art shall appreciate that modifications can still be made to the technical solutions disclosed in the above embodiments or equivalent substations may be made to some of the technical features, and the corresponding technical solutions will not depart from the scope of the present disclosure due to such modifications or substations.

What is claimed is:

1. A lighting projection device, comprising:
a light source of three primary colours comprising a first light source, a second light source and a third light source;
a first collimating lens group positioned on a light path of the first light source, a second collimating lens group positioned on a light path of the second light source, and a third collimating lens group positioned on a light path of the third light source;
a first dichroic mirror and a second dichroic mirror; and
a first fly-eye lens, a second fly-eye lens, and a third fly-eye lens, the first fly-eye lens, the second fly-eye lens and the third fly-eye lens each comprising a light incident surface facing the light source of three primary colours, and the light incident surface of each of the first fly-eye lens, the second fly-eye lens, and the third fly-eye lens comprising the same fly-eye lens array;
wherein,
a light beam emitted from the first light source is collimated by the first collimating lens group and penetrates through the first dichroic mirror, and a light beam emitted from the second light source is collimated by the second collimating lens group and is reflected by the first dichroic mirror; the first fly-eye lens is positioned on a light path of the first dichroic mirror, and the light beam penetrating through the first dichroic mirror and the light beam reflected by the first dichroic mirror converge on a light incident surface of the first fly-eye lens;
the second fly-eye lens is positioned on a light path of the third collimating lens group, a light beam emitted from the third light source is collimated by the third collimating lens group and enters the light incident surface of the second fly-eye lens;
a light beam from the first fly-eye lens is reflected by the second dichroic mirror, and a light beam from the second fly-eye lens penetrates through the second dichroic mirror; the third fly-eye lens is positioned on a light path of the second dichroic mirror; and the light beam penetrating through the second dichroic mirror and the light beam reflected by the second dichroic mirror converge on a light incident surface of the third fly-eye lens.

2. The lighting projection device according to claim 1, wherein the first dichroic mirror is parallel to the second dichroic mirror.

3. The lighting projection device according to claim 1, wherein the first fly-eye lens comprises a light emitting surface opposite to the light incident surface thereof, the second fly-eye lens comprises a light emitting surface opposite to the light incident surface thereof, the third fly-eye lens comprises a light emitting surface opposite to the light incident surface thereof, the light emitting surfaces of the first, second and third fly-eye lenses are all flat or curved surfaces.

4. The lighting projection device according to claim 1, wherein an optical axis of the second fly-eye lens is coaxial with that of the third fly-eye lens, and is vertical to an optical axis of the first fly-eye lens.

5. The lighting projection device according to claim 1, wherein the light incident surfaces of the first fly-eye lens, the second fly-eye lens and the third fly-eye lens facing the light source of three primary colours each comprise a single face fly-eye lens array comprising a plurality of small lenses.

6. The lighting projection device according to claim 5, wherein the first fly-eye lens, the second fly-eye lens and the third fly-eye lens are configured to homogenize light beams.

7. The lighting projection device according to claim 1, wherein an optical axis of the first collimating lens group is coincident to that of the first light source, an optical axis of the second collimating lens group is coincident to that of the second light source, and an optical axis of the third collimating lens group is coincident to that of the third light source.

8. The lighting projection device according to claim 1, wherein an optical axis of the first collimating lens group is vertical to an optical axis of the second or third collimating lens group.

9. The lighting projection device according to claim 1, wherein an included angle between the first dichroic mirror and an optical axis of the first collimating lens group is 45 degrees, and an included angle between the first dichroic mirror and an optical axis of the second collimating lens group is 45 degrees; an included angle between the second dichroic mirror and an optical axis of the first collimating lens group is 45 degrees, and an included angle between the second dichroic mirror and an optical axis of the third collimating lens group is 45 degrees.

10. The lighting projection device according to claim 1, wherein the first collimating lens group, the second collimating lens group, and the third collimating lens group employ curved lenses.

11. The lighting projection device according to claim 1, wherein a light incident surface of the first dichroic mirror facing the first light source is provided with an anti-reflective coating, and a light incident surface of the first dichroic mirror facing the second light source is provided with a reflection increasing coating; a light incident surface of the second dichroic mirror facing the first fly-eye lens is provided with a reflection increasing coating, and a light incident surface of the second dichroic mirror facing the second fly-eye lens is provided with an anti-reflective coating.

12. The lighting projection device according to claim 1, wherein the light source of three primary colours comprises LED light sources or laser light sources.

13. The lighting projection device according to claim 1, wherein the light source of three primary colours comprises a red light source, a blue light source and a green light source.

14. A projection module, comprising:
a lighting projection device of claim 1, a relay lens positioned on the light path of the third fly-eye lens, wherein a homogenized light beam emitted from the lighting projection device is received and converged by the relay lens;
a rectangular prism positioned on the light path of the relay lens;
a display chip positioned at the side of the rectangular prism, wherein a light beam emitted from the relay lens is guided to the display chip; and
a projection lens group, wherein a projection beam from the display chip is reflected by a side face of the rectangular prism and is guided to the projection lens group.

15. The projection module according to claim 14, wherein the display chip is DMD or LCOS or LCD.

16. The projection module according to claim 14, wherein the first dichroic mirror is parallel to the second dichroic mirror.

17. The projection module according to claim 14, wherein the first fly-eye lens comprises a light emitting surface opposite to the light incident surface thereof, the second fly-eye lens comprises a light emitting surface opposite to the light incident surface thereof, the third fly-eye lens comprises a light emitting surface opposite to the light incident surface thereof, the light emitting surfaces of the first, second and third fly-eye lenses are all flat or curved surfaces.

18. The projection module according to claim 14, wherein an optical axis of the second fly-eye lens is coaxial with that of the third fly-eye lens, and is vertical to an optical axis of the first fly-eye lens.

19. The projection module according to claim 14, wherein the light incident surfaces of the first fly-eye lens, the second fly-eye lens and the third fly-eye lens facing the light source of three primary colours each comprise a single face fly-eye lens array comprising a plurality of small lenses.

20. The projection module according to claim 14, wherein an optical axis of the first collimating lens group is vertical to an optical axis of the second or third collimating lens group.
